(19) United States
(12) Patent Application Publication
(10) Pub. No.: US 2014/0232452 A1
(43) Pub. Date: Aug. 21, 2014

(54) INTERNAL VOLTAGE GENERATION CIRCUIT

(71) Applicant: RENESAS ELECTRONICS CORPORATION, Kawasaki-shi (JP)

(72) Inventor: Junko MATSUMOTO, Kawasaki-shi (JP)

(73) Assignee: RENESAS ELECTRONICS CORPORATION, Kawasaki-shi (JP)

(21) Appl. No.: 14/175,481

(22) Filed: Feb. 7, 2014

(30) Foreign Application Priority Data
Feb. 20, 2013 (JP) 2013-030803

(51) Int. Cl. H02M 3/07

(52) U.S. Cl. CPC H02M 3/07
USPC 327/536

(57) ABSTRACT

In an internal voltage generation circuit, four charge pump circuits are provided, the first two charge pump circuits are driven with a long period at the time of standby mode, and the four charge pump circuits are driven with a short period at the time of active mode. Therefore, a layout area can be reduced compared with a case where a charge pump circuit for standby mode and a charge pump circuit for active mode are provided separately.

### CROSS-REFERENCE TO RELATED APPLICATIONS

The disclosure of Japanese Patent Application No. 2013-030803 filed on Feb. 20, 2013 including the specifications, drawings and abstract is incorporated herein by reference in its entirety.

### BACKGROUND

The present invention relates to an internal voltage generation circuit, which can be used suitably for an internal voltage generation circuit for generating an internal power supply voltage based on an external power supply voltage, for example, in a semiconductor device having a standby mode and an active mode.

Conventionally, an internal voltage generation circuit for generating an internal power supply voltage based on an external power supply voltage and an internal circuit driven by the internal power supply voltage are mounted on a semiconductor device like semiconductor memory. The internal voltage generation circuit includes a charge pump circuit. Moreover, the semiconductor device has the standby mode in which the internal circuit does not operate but a consumption current is intended to be reduced, and the active mode in which the internal circuit operates and the consumption current for driving the internal circuit becomes necessary.

Patent Document 1 discloses a semiconductor device that has a first internal voltage generation circuit that is activated at the time of standby mode and whose current supply capability is small, and a second internal voltage generation circuit that is activated at the time of active mode and whose current supply capability is large.

Moreover, Patent Documents 2, 3 disclose semiconductor devices each of which has an oscillation circuit that gives a clock signal of a long period to the charge pump circuit at the time of standby mode, and gives a clock signal of a short period to the charge pump circuit at the time of active mode.

Moreover, Patent Document 4 discloses a semiconductor device that has multiple charge pump circuits, activates only a part of the charge pump circuits at the time of standby mode, and activates all the charge pump circuits at the time of active mode.

Patent Document 1: Japanese Unexamined Patent Application Publication No. 2002-74956

Patent Document 2: Japanese Unexamined Patent Application Publication No. Hei7(1995)-65576

Patent Document 3: Japanese Unexamined Patent Application Publication No. Hei7(1995)-303369

Patent Document 4: Japanese Unexamined Patent Application Publication No. 2002-32987

### SUMMARY

However, a semiconductor device of the related art had a problem that a layout area of the internal voltage generation circuit was large.

Other problems and new features will become clear from description and accompanying drawings of this specification.

According to an aspect of the present invention, a semiconductor device has first and second charge pump circuits, gives a clock signal of a long period to the first charge pump circuit at the time of standby mode, and gives a clock signal of a short period to the first and second charge pump circuits at the time of active mode.

According to the aspect of the present invention, compared with a case where a charge pump circuit for standby mode and a charge pump circuit for active mode are provided separately, a layout area of the internal voltage generation circuit can be reduced.

### BRIEF DESCRIPTION OF THE DRAWINGS

FIG. 1 is a block diagram showing a principal part of a semiconductor device according to a first embodiment of the present application;

FIG. 2 is a circuit diagram showing a configuration of a frequency divider shown in FIG. 1;

FIGS. 3A to 3D are time charts showing an operation of the frequency divider shown in FIG. 2 at the time of standby mode, in which FIG. 3A is an ACTEN signal, FIG. 3B is an ACLK signal, FIG. 3C is an SCLK signal, FIG. 3D is a PCLKA1 signal, and FIG. 3E is a PCLKA2 signal;

FIGS. 4A to 4H are time charts showing an operation of the frequency divider shown in FIG. 2 at the time of active mode, in which FIG. 4A is the ACTEN signal, FIG. 4B is the ACLK signal, FIG. 4C is a CLK1 signal, FIG. 4D is a CLK2 signal, FIG. 4E is the PCLKA1 signal, FIG. 4F is the PCLKA2 signal, FIG. 4G is a PCLKB1 signal, and FIG. 4H is a PCLKB2 signal;

FIG. 5 is a circuit diagram showing configurations of charge pump circuits PA1, PA2 shown in FIG. 1;

FIGS. 6A to 6H are time charts showing operations of the charge pump circuits PA1, PA2 shown in FIG. 5, in which FIG. 6A is the PCLKA1 signal, FIG. 6B is the PCLKA2 signal, FIG. 6C is an N1a voltage, FIG. 6D is an N1b voltage, FIG. 6E is an N2a voltage, FIG. 6F is an N2b voltage, FIG. 6G is an N3 voltage, and FIG. 6H is an N4 voltage;

FIG. 7 is a circuit diagram showing configurations of charge pump circuits PB1, and PB2 shown in FIG. 1;

FIGS. 8A to 8F are time charts showing an operation of the semiconductor device shown in FIG. 1 at the time of standby mode, in which FIG. 8A is an EN signal, FIG. 8B is a VPP voltage, FIG. 8C is a STBEN signal, FIG. 8D is the SCLK signal, FIG. 8E is the PCLKA1 signal, and FIG. 8F is the PCLKA2 signal;

FIGS. 9A to 9I are time charts showing an operation of the semiconductor device shown in FIG. 1 at the time of active mode, in which FIG. 9A is the EN signal, FIG. 9B is the VPP voltage, FIG. 9C is I(VPP), FIG. 9D is the ACTEN signal, FIG. 9E is the ACLK signal, FIG. 9F is the PCLKA1 signal, FIG. 9G is the PCLKA2 signal, FIG. 9H is the PCLKB1 signal, and FIG. 9I is the PCLKB2 signal;

FIGS. 10A to 10H are another time charts showing an operation of the semiconductor device shown in FIG. 1 at the time of active mode, in which FIG. 10A is the EN signal, FIG. 10B is the ACTEN signal, FIG. 10C is the ACLK signal, FIG. 10D is the PCLKA1 signal, FIG. 10E is the PCLKA2 signal, FIG. 10F is the PCLKB1 signal, FIG. 10G is the PCLKB2 signal, and FIG. 10H is the VPP voltage;

FIG. 11 is a block diagram showing a principal part of a semiconductor device according to a second embodiment of the present application; and

FIG. 12 is a circuit diagram showing configurations of charge pump circuits PC1, PC shown in FIG. 11.

### DETAILED DESCRIPTION

### First Embodiment

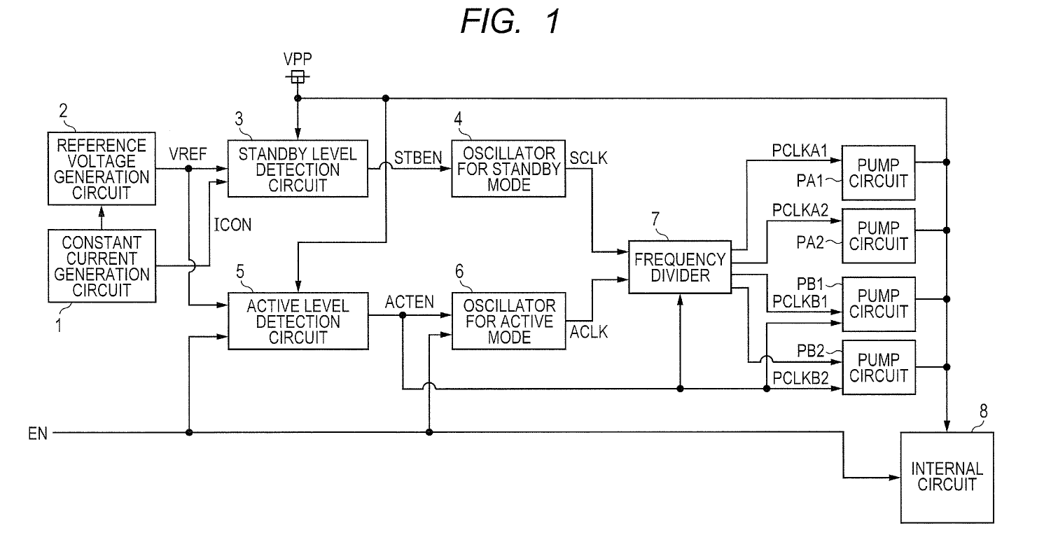

A semiconductor device according to a first embodiment of the present application has a constant current generation circuit 1, a reference voltage generation circuit 2, a standby level detection circuit 3, an oscillator 4 for standby mode, an active level detection circuit 5, and an oscillator 6 for active mode as shown in FIG. 1. Moreover, this semiconductor device includes a frequency divider 7 and charge pump circuits PA1, PA2, PB1, and PB2, and an internal circuit 8.

An internal voltage generation circuit for generating an internal power supply voltage VPP based on an external power supply voltage VCC is comprised of portions other than the internal circuit 8. The internal circuit 8 is driven by the internal power supply voltage VPP, and performs a predetermined operation. Moreover, this semiconductor device has a standby mode in which the internal circuit 8 does not operate and its consumption current is intended to be suppressed, and an active mode in which the internal circuit 8 operates and a current for driving the internal circuit 8 becomes necessary.

The constant current generation circuit 1 generates a constant current ICON without temperature dependency, and gives it to the reference voltage generation circuit 2 and the standby level detection circuit 3. The reference voltage generation circuit 2 generates a constant reference voltage VREF based on the constant current ICON, and gives the reference voltage VREF to the standby level detection circuit 3 and the active level detection circuit 5.

The standby level detection circuit 3 operates based on the constant current ICON, compares heights of a target voltage VPPT that is a prescribed voltage on the basis of the reference voltage VREF and the internal power supply voltage VPP, and generates a standby oscillator activation signal STBEN based on a comparison result. When the internal power supply voltage VPP is lower than the target voltage VPPT, the signal STBEN becomes the “H” level of an activation level; when the internal power supply voltage VPP is more than or equal to the target voltage VPPT, the signal STBEN becomes the “L” level of a deactivation level.

When the signal STBEN is the “H” level of the activation level, the oscillator 4 for standby mode generates a standby clock signal SCLK of a long period; when the signal STBEN is the “L” level of the deactivation level, it suspends generation of the standby clock signal SCLK.

The active level detection circuit 5 is activated when an activation signal EN is on the “H” level, compares heights of the internal power supply voltage VPP and the target voltage VPPT, and generates an active oscillator activation signal ACTEN based on a comparison result. The activation signal EN is made to be “H” level of the activation level at the time of active mode, and is made to be “L” level of the deactivation level at the time of standby mode.

The active oscillator activation signal ACTEN is made to be “H” level of the activation level when the internal power supply voltage VPP is lower than the target voltage VPPT; it is made to be “L” level of the deactivation level when the internal power supply voltage VPP is more than or equal to the target voltage VPPT. A response speed of the active level detection circuit 5 is faster than a response speed of the standby level detection circuit 3. A current driving capability and a consumption current of the active level detection circuit 5 are larger than a current driving capability and a consumption current of the standby level detection circuit 3, respectively.

The oscillator 6 for active mode generates an active clock signal ACLK of a short period when the signal ACTEN is on the “H” level of the activation level; it suspends generation of the active clock signal ACLK when the signal ACTEN is on the “L” level of the deactivation level. A frequency of the active clock signal ACLK is higher than a frequency of the standby clock signal SCLK.

The frequency divider 7 generates charge pump clock signals PCLKA1, PCLKA2 based on the standby clock signal SCLK at the time of standby mode. Moreover, the frequency divider 7 generates charge pump clock signals PCLKA1, PCLKA2, PCLKB1, and PCLKB2 based on the active clock signal ACLK at the time of active mode.

Periods of the charge pump clock signals PCLKA1, PCLKA2 at the time of standby mode are longer than periods of the charge pump clock signals PCLKA1, PCLKA2, PCLKB1, and PCLKB2 at the time of active mode. Moreover, the charge pump clock signal PCLKA2 is an inverted signal of the charge pump clock signal PCLKA1. The charge pump clock signal PCLKB2 is an inverted signal of the charge pump clock signal PCLKB1.

The charge pump circuits PA1, PA2, PB1, and PB2 are driven by the charge pump clock signals PCLKA1, PCLKA2, PCLKB1, and PCLKB2, respectively, to supply positive charges to a line of the internal power supply voltage VPP. The internal power supply voltage VPP is higher than the external power supply voltage VCC. When the activation signal EN is on the “H” level of the activation level, the internal circuit 8 is activated and is driven by the internal power supply voltage VPP to perform a predetermined operation. Moreover, when the activation signal EN is on the “L” level of the deactivation level, the internal circuit 8 is deactivated and does not operate.

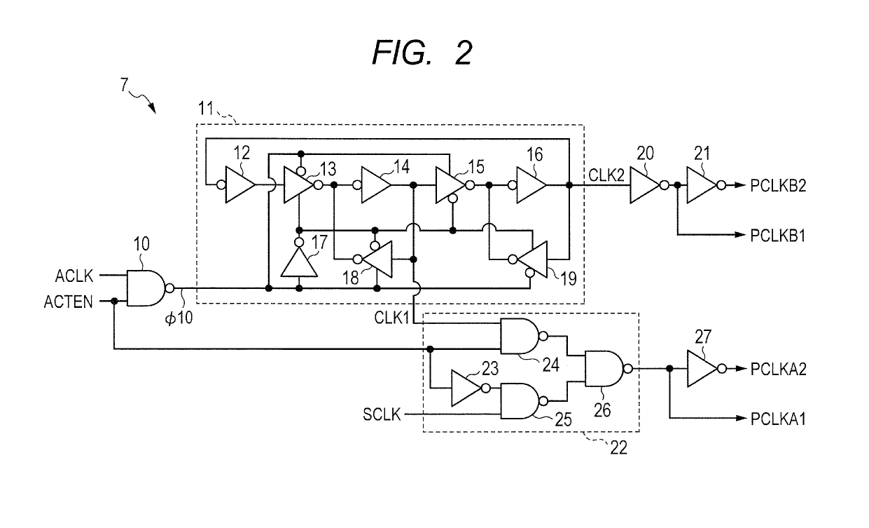

FIG. 2 is a circuit diagram showing a configuration of the frequency divider 7. In FIG. 2, the frequency divider 7 includes a NAND gate 10, a frequency divider 11, inverters 20, 21, and 27, and a selection circuit 22. The NAND gate 10 receives the active clock signal ACLK and the active oscillator activation signal ACTEN, and outputs their NAND signal φ10. The output signal φ10 of the NAND gate 10 is given to the frequency divider 11.

The frequency divider 11 includes inverters 12, 14, 16, and 17 and clocked inverters 13, 15, 18, and 19. The inverters 12 to 16 are coupled in a ring shape. The clocked inverters 18, 19 are coupled to the inverters 14, 16 in reverse parallel, respectively. The output signal φ10 of the NAND gate 10 is inputted into negative side control terminals of the clocked inverters 13, 19 and into positive side control terminals of the clocked inverters 15, 18. Moreover, the signal φ10 is inverted by the inverter 17 and is inputted into positive side control terminals of the clocked inverters 13, 19 and into negative side control terminals of the clocked inverters 15, 18, respectively. Output signals of the inverters 14, 16 become clock signals CLK1, CLK2, respectively.

When the signal φ10 is on the “L” level, each of the clocked inverters 13, 19 is activated and operates as an inverter, and the clocked inverters 15, 18 are deactivated, so that output nodes of the clocked inverters 15, 18 become high impedance. Moreover, since the clocked inverter 13 is activated and the clock signal CLK2 is inverted by the inverters 12 to 14 to become the clock signal CLK1, logic levels of the clock signals CLK1, CLK2 are different.

When the signal φ10 is on the “H” level, each of the clocked inverters 15, 18 is activated and operates as an inverter and, at the same time, the clocked inverters 13, 19 is deactivated, so that output nodes of the clocked inverters 13, 19 become high impedance. Moreover, since the clocked inverter 15 is activated and the clock signal CLK1 is delayed by the inverters 15, 16, to become the clock signal CLK2, the logic levels of the clock signals CLK1, CLK2 become the same.

A logic level of the clock signal CLK2 is inverted each time the signal φ10 is raised to the “H” level from the “L” level; a logic level of the clock signal CLK1 is inverted each time the signal φ10 is lowered to the “L” level from the “H” level.

The clock signal CLK2 is inverted by the inverter 20 to become the charge pump clock signal PCLKB1. The charge pump clock signal PCLKB1 is inverted by the inverter 21 to become the charge pump clock signal PCLKB2.

The selection circuit 22 includes an inverter 23 and NAND gates 24 to 26. The inverter 23 inverts the active oscillator activation signal ACTEN. The NAND gate 24 outputs an NAND signal of the clock signal CLK1 and the signal ACTEN. The NAND gate 25 outputs an NAND signal of the output signal of the inverter 23 and the standby clock signal SCLK. The NAND gate receives output signals of the NAND gates 24, 25, and outputs the charge pump clock signal PCLKA1. The charge pump clock signal PCLKA1 is inverted by the inverter 27 to become the charge pump clock signal PCLKA2.

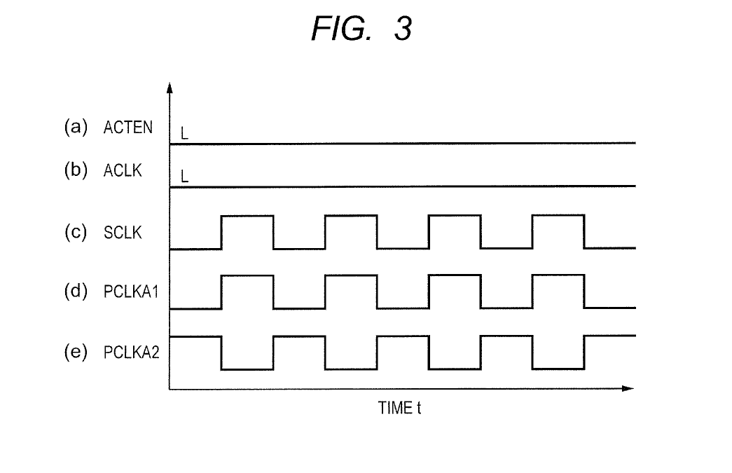

FIGS. 3A to 3E are time charts showing an operation of the frequency divider 7 at the time of standby mode. In the standby mode, the activation signal EN is made to be “L” level of the deactivation level, and both the active oscillator activation signal ACTEN and the active clock signal ACLK are fixed to the “L” level. Thereby, the output signal φ10 of the NAND gate 10 of FIG. 2 is fixed to the “H” level. Both the clock signals CLK1, CLK2 are fixed to the “L” level or the “H” level, and each of the charge pump clock signals PCLKB1, PCLKB2 is fixed to the “H” level or the “L” level.

Moreover, an output signal of the NAND gate 24 is fixed to the “H” level, and each of the NAND gates 25, 26 operates as an inverter. Therefore, the standby clock signal SCLK is delayed by the NAND gates 25, 26 to become the charge pump clock signal PCLKA1. Moreover, the charge pump clock signal PCLKA1 is inverted by the inverter 27 to become the charge pump clock signal PCLKA2.

That is, in the standby mode, as shown in FIGS. 3A to 3E, the standby clock signal SCLK of the long period is outputted as the charge pump clock signal PCLKA1, and the charge pump clock signals PCLKA1, PCLKA2 become mutually complementary signals. Moreover, each of the charge pump clock signals PCLKB1, PCLKB2 is fixed to the “H” level or the “L” level.

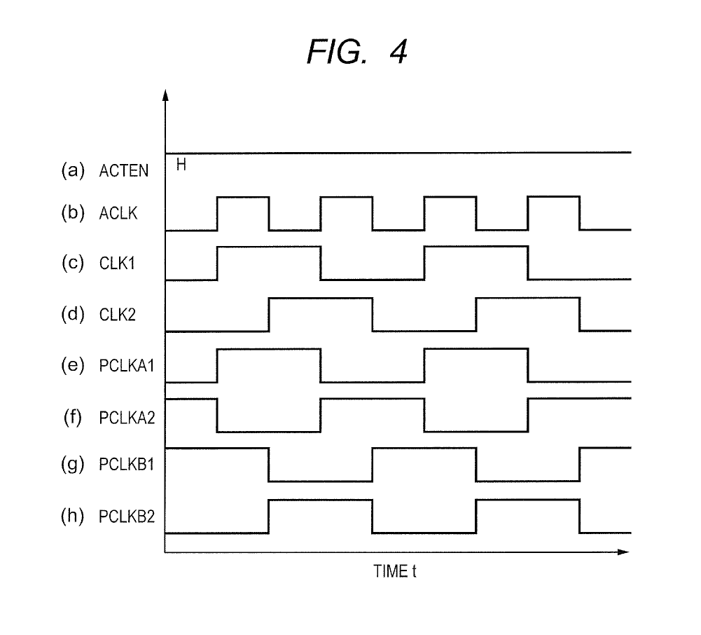

FIGS. 4A to 4H are time charts showing an operation of the frequency divider 7 at the time of active mode. FIGS. 4A to 4H show a case where the internal power supply voltage VPP is lower than the target voltage VPPT at the time of active mode. In this case, the active oscillator activation signal ACTEN is made to be “H” level of the activation level by the active level detection circuit 5, and the active clock signal ACLK of the short period is generated by the oscillator 6 for active mode.

Thereby, the output signal φ10 of the NAND gate 10 of FIG. 2 becomes an inverted signal of the active clock signal ACLK. The logic level of the clock signal CLK1 is inverted each time the active clock signal ACLK is raised to the “H” level from the “L” level, and the logic level of the clock signal CLK2 is inverted each time the active clock signal ACLK is lowered to the “L” level from the “H” level. Therefore, the clock signal CLK1 becomes a signal such that the active clock signal ACLK is frequency doubled, and the clock signal CLK2 becomes a signal such that the clock signal CLK1 is delayed by ¼ period. The clock signal CLK2 is inverted by the inverter 20 to become the charge pump clock signal PCLKB1. Moreover, the charge pump clock signal PCLKB1 is inverted by the inverter 21 to become the charge pump clock signal PCLKB2.

Moreover, the output signal of the NAND gate 25 is fixed to the “H” level, and each of the NAND gates 24, 26 operates as an inverter. Therefore, the clock signal CLK1 is delayed by the NAND gates 24, 26 to become the charge pump clock signal PCLKA1. Moreover, the charge pump clock signal PCLKA1 is inverted by the inverter 27 to become the charge pump clock signal PCLKA2.

That is, in the active mode, as shown in FIGS. 4A to 4H, the clock signal CLK1 obtained by frequency doubling the active clock signal ACLK is outputted as the charge pump clock signal PCLKA1, and the charge pump clock signals PCLKA1, PCLKA2 become mutually complementary signals. Moreover, a signal such that the charge pump clock signal PCLKA2 is delayed by ¼ period becomes the charge pump clock signal PCLKB1, and the charge pump clock signals PCLKB1, PCLKB2 become mutually complementary signals.

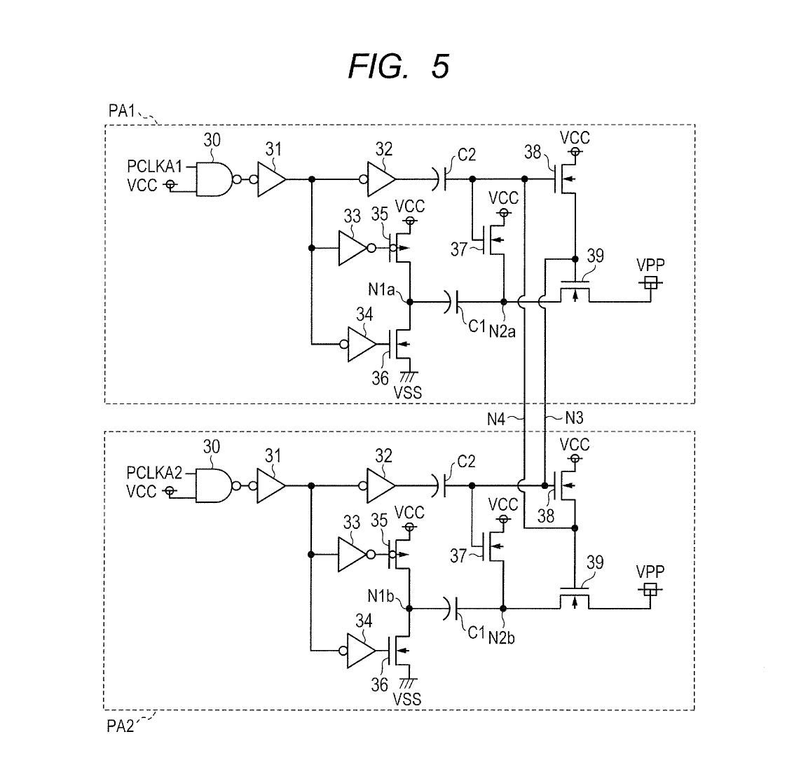

FIG. 5 is a circuit diagram showing configurations of the charge pump circuits PA1, PA2. In FIG. 5, the charge pump circuit PA1 includes a NAND gate 30, inverters 31 to 34, capacitors C1, C2, a P-channel MOS transistor 35, and N-channel metal oxide semiconductor transistors 36 to 39.

A one electrode (a node N1a) of the capacitor C1 is coupled to a line of the external power supply voltage VCC through the P-channel MOS transistor 35 and, at the same time, is coupled to a line of a ground voltage VSS through the N-channel metal oxide semiconductor transistor 36. Another electrode (a node N2a) of the capacitor C1 is coupled to the line of the internal power supply voltage VPP through the N-channel metal oxide semiconductor transistor 39 and, at the same time, is coupled to the line of the external power supply voltage VCC through the N-channel metal oxide semiconductor transistor 37. A gate of the N-channel metal oxide semiconductor transistor 39 is coupled to the line of the external power supply voltage VCC through the N-channel metal oxide semiconductor transistor 38. Gates of the N-channel metal oxide semiconductor transistors 37, 38 are coupled to each other.

A one input node of the NAND gate 30 receives the charge pump clock signal PCLKA1, and another input node thereof receives the external power supply voltage VCC. The NAND gate 30 operates as an inverter to the charge pump clock signal PCLKA1. An output signal of the NAND gate 30 is given to the gates of the N-channel metal oxide semiconductor transistors 37, 38 through the inverters 31, 32 and the capacitor C2. An output signal of the inverter 31 is given to a gate of the N-channel metal oxide semiconductor transistor 36 through the inverter 34 and, at the same time, is given to a gate of the P-channel MOS transistor 35 through the inverter 33.

Although the charge pump circuit PA2 differs in that the charge pump clock signal PCLKA2 is given instead of the charge pump clock signal PCLKA1, it is of the same configuration as that of the charge pump circuit PA1. However, a one electrode of the capacitor C1 is called a node N1b, and the other electrode thereof is called a node N2b.

Moreover, both the gate of the N-channel metal oxide semiconductor transistor 39 of the charge pump circuit PA1 and a gate of the N-channel metal oxide semiconductor transistor 38 of the charge pump circuit PA2 are coupled to a node N3. Moreover, both the gate of the N-channel metal oxide semiconductor transistor 38 of the charge pump circuit PA1 and the gate of the N-channel metal oxide semiconductor transistor 39 of the charge pump circuit PA2 are coupled to a node N4.

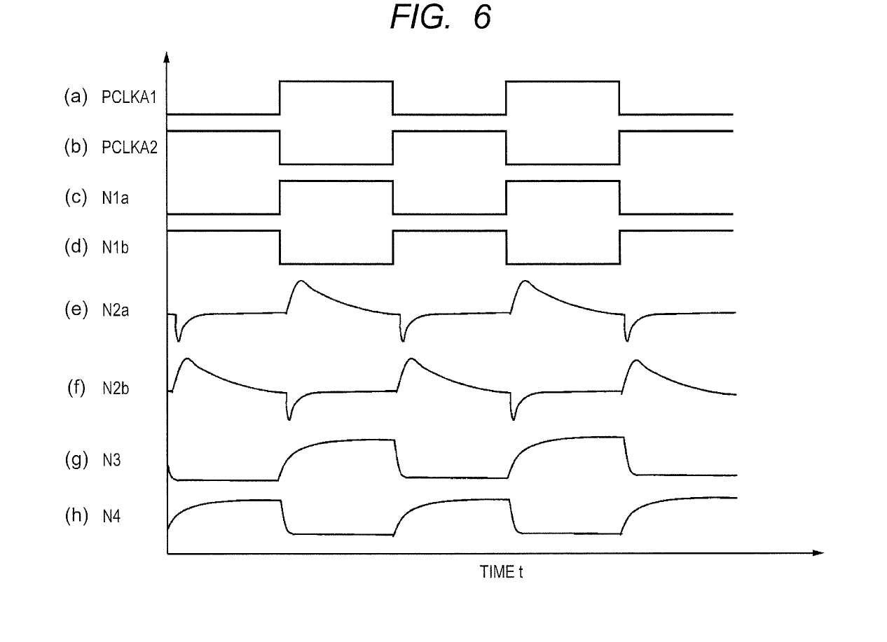

FIGS. 6A to 6H are time charts showing operations of the charge pump circuits PA1, PA2. In FIGS. 6A to 6H, the charge pump clock signals PCLKA1, PCLKA2 are mutually complementary clock signals.

When the charge pump clock signal PCLKA1 changes from the “L” level to the “H” level, the N-channel metal oxide semiconductor transistor 36 of the charge pump circuit PA1 changes from ON state to OFF state and, at the same time, the P-channel MOS transistor 35 changes from OFF state to ON state. Thereby, a level of the node N1a is boosted to the external power supply voltage VCC from the ground voltage VSS, and a level of the node N2a rises through the capacitor C1.

At this time, the charge pump clock signal PCLKA2 changes from the “H” level to the “L” level and a level of the node N3 rises by the capacitor C2 of the charge pump circuit PA2. Thereby, the N-channel metal oxide semiconductor transistor 39 of the charge pump circuit PA1 turns on, and electric charges of the node N2a are efficiently transferred to the line of the internal power supply voltage VPP.

Since the node N3 is coupled also to the gates of the N-channel metal oxide semiconductor transistors 37, 38 of the charge pump circuit PA2, their transistors 37, 38 also turn on, and the external power supply voltage VCC is given to the node N2b of the charge pump circuit PA2 and the gate (the node N4) of the N-channel metal oxide semiconductor transistor 39. This prepares for an operation for supplying a current from the charge pump circuit PA2 to the line of the internal power supply voltage VPP caused by a rise of the next charge pump clock signal PCLKA2.

That is, the charge pump circuit PA1 supplies positive charges to the line of the internal power supply voltage VPP each time the charge pump clock signal PCLKA1 is raised to the “H” level from the “L” level. The charge pump circuit PA2 supplies positive charges to the line of the internal power supply voltage VPP each time the charge pump clock signal PCLKA2 is raised to the “H” level from the “L” level. The charge pump circuits PA1, PA2 supply positive charges to the line of the internal power supply voltage VPP alternately.

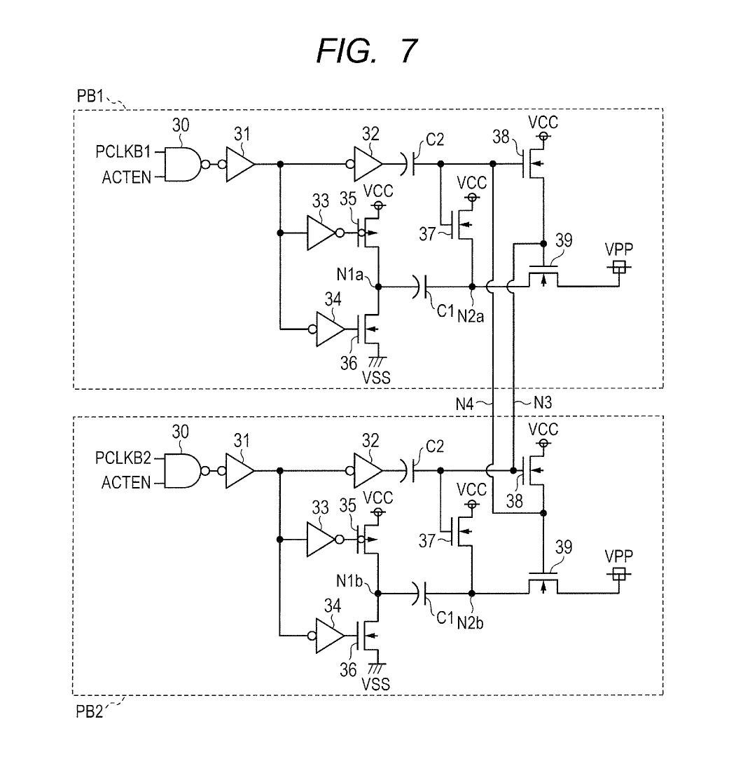

FIG. 7 is a circuit diagram showing a configuration of the charge pump circuits PB1, PB2, and is a figure that is contrasted with FIG. 5. With reference to FIG. 7, the charge pump circuits PA1, PA2 have the same configurations as those of the charge pump circuits PB1, PB2. However, the one input node of the NAND gate 30 of the charge pump circuit PB1 receives the charge pump clock signal PCLKB1, and the other input node thereof receives the active oscillator activation signal ACTEN.

When the signal ACTEN is the “H” level of the activation level, the NAND gate 30 operates as an inverter to the charge pump clock signal PCLKB1. The charge pump circuit PB1 supplies positive charges to the line of the internal power supply voltage VPP in response to the charge pump clock signal PCLKB1. When the signal ACTEN is the “L” level of the deactivation level, the output signal of the NAND gate 30 is fixed to the “H” level and the charge pump circuit PB1 does not operate.

Moreover, the one input node of the NAND gate 30 of the charge pump circuit PB2 receives the charge pump clock signal PCLKB2; the other input node thereof receives the active oscillator activation signal ACTEN.

When the signal ACTEN is the “H” level of the activation level, the NAND gate 30 operates as an inverter to the charge pump clock signal PCLKB2. The charge pump circuit PB2 supplies electric charges to the line of the internal power supply voltage VPP in response to the charge pump clock signal PCLKB2. When the signal ACTEN is on the “L” level of the deactivation level, the output signal of the NAND gate 30 is fixed to the “H” level and the charge pump circuit PB2 does not operate.

That is, the charge pump circuit PB1 supplies positive charges to the line of the internal power supply voltage VPP each time the charge pump clock signal PCLKB1 is raised to the “H” level from the “L” level. The charge pump circuit PB2 supplies positive charges to the line of the internal power supply voltage VPP each time the charge pump clock signal PCLKB2 is raised to the “H” level from the “L” level. The charge pump circuits PB1, PB2 supply positive charges to the line of the internal power supply voltage VPP alternately.

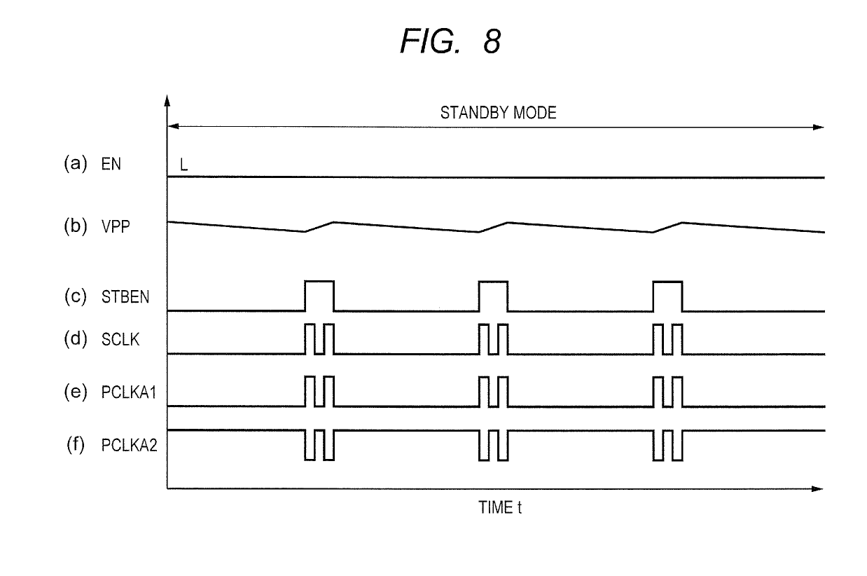

FIGS. 8A to 8F are time charts showing an operation of the semiconductor device at the time of standby mode. In FIGS. 8A to 8F, at the time of standby mode, the activation signal EN is made to be “L” level of the deactivation level at the time of standby mode. When the activation signal EN is made to be “L” level, the active level detection circuit 5, the oscillator 6 for active mode, the charge pump circuits PB1, PB2, and the internal circuit 8 of FIG. 1 are deactivated and do not operate.

Even when the internal circuit 8 does not operate, if it is set aside for a long time, a potential level of the internal power supply voltage VPP will lower because of a leakage current etc. When the potential level of the internal power supply voltage VPP lowers from the target voltage VPPT, the standby oscillator activation signal STBEN is made to be “H” level of the activation level by the standby level detection circuit 3. When the signal STBEN is made to be “H” level, the oscillator 4 for standby mode is activated and the standby clock signal SCLK of the long period is generated.

Based on the standby clock signal SCLK, the frequency divider 7 generates the charge pump clock signals PCLKA1, PCLKA2 that are mutually complementary, which are supplied to the charge pump circuits PA1, PA2. In response to the charge pump clock signals PCLKA1, PCLKA2, the charge pump circuits PA1, PA2 supply positive charges to the line of the internal power supply voltage VPP alternately.

When the internal power supply voltage VPP reaches the target voltage VPPT, the standby oscillator activation signal STBEN is made to be “L” level of the deactivation level. When the signal STBEN is made to be “L” level, the oscillator 4 for standby mode is deactivated, the standby clock signal SCLK is fixed to the “L” level, and the charge pump clock signals PCLKA1, PCLKA2 are fixed to the “L” level and the “H” level, respectively. Thereby, supply of the positive charges to the line of the internal power supply voltage VPP from the charge pump circuits PA1, PA2 is suspended.

Thus, in the standby mode, only two charge pump circuits PA1, PA2 among the four charge pump circuits PA1, PA2, PB1, and PB2 are driven by the charge pump clock signals PCLKA1, PCLKA2 of the long period. Therefore, reduction of the consumption current can be attained.

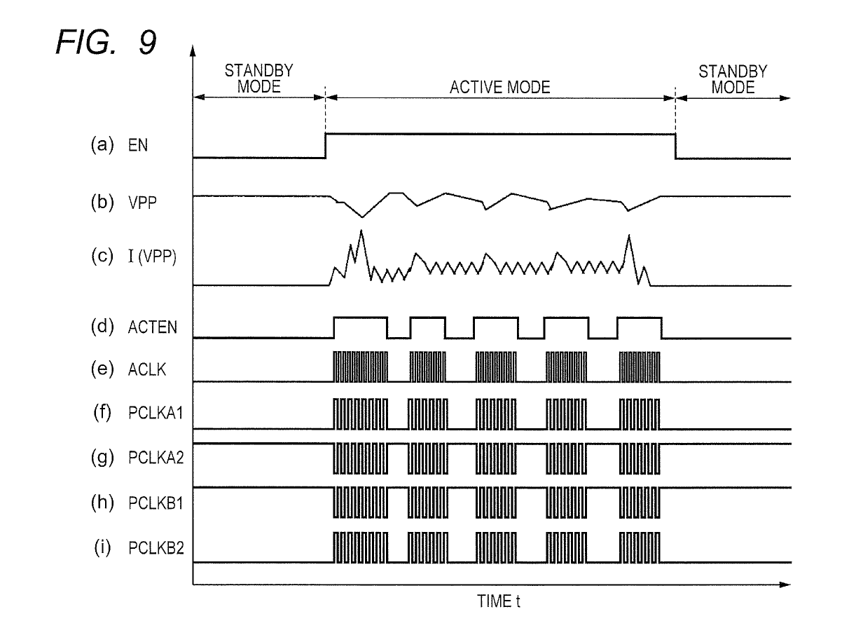

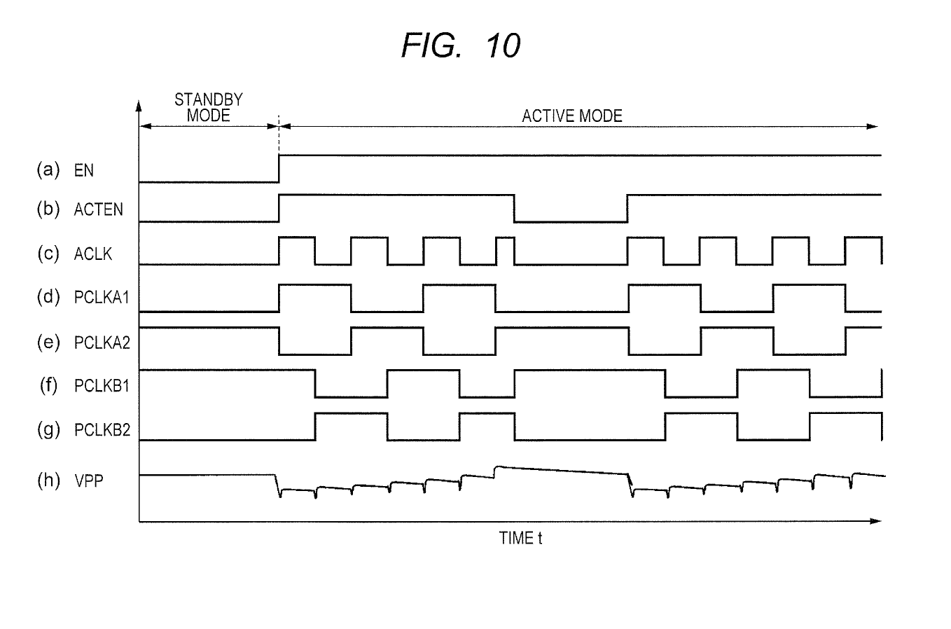

FIGS. 9A to 9I and FIGS. 10A to 10H are time charts showing an operation of the semiconductor device at the time of active mode. In FIGS. 9A to 9I and FIGS. 10A to 10H, the activation signal EN is made to be “H” level of the activation level at the time of active mode. When the activation signal EN is made to be “H” level, the internal circuit 8 and the active level detection circuit 5 of FIG. 1 start their operations. When the internal circuit 8 operates, the internal power supply voltage VPP is used and its potential level lowers.

When the active level detection circuit 5 detects that the potential level of the internal power supply voltage VPP lowers from the target voltage VPPT, the active oscillator activation signal ACTEN is made to be “H” level of the activation level. By this, the oscillator 6 for active mode generates the active clock signal ACLK of the short period, and the frequency divider 7 generates the charge pump clock signals PCLKA1, PCLKA2, PCLKB1, and PCLKB2 and also activates the charge pump circuits PB1, PB2.

The charge pump clock signals PCLKA1, PCLKA2 become mutually complementary signals. Moreover, a signal such that the charge pump clock signal PCLKA2 is delayed by ¼ period becomes the charge pump clock signal PCLKB1, and the charge pump clock signals PCLKB1, PCLKB2 become mutually complementary signals. Moreover, a period of the charge pump clock signals PCLKA1, PCLKA2, PCLKB1, and PCLKB2 at the time of active mode is shorter than a period of the charge pump clock signals PCLKA1, PCLKA2 at the time of standby mode.

The charge pump circuits PA1, PA2, PB1, and PB2 supply positive charges to the line of the internal power supply voltage VPP in response to the charge pump clock signals PCLKA1, PCLKA2, PCLKB1, and PCLKB2, respectively. Therefore, a current supply capability of the internal voltage generation circuit at the time of active mode becomes larger enough than a current supply capability at the time of standby mode.

When the potential level of the internal power supply voltage VPP rises to be more than or equal to the target voltage VPPT, the active oscillator activation signal ACTEN is lowered to the “L” level of the deactivation level by the active level detection circuit 5. When the signal ACTEN is made to be “L” level, the oscillator 6 for active mode is deactivated and the active clock signal ACLK is fixed to the “L” level. Moreover, the frequency divider 7 fixes each of the charge pump clock signals PCLKA1, PCLKA2, PCLKB1, and PCLKB2 to the “L” level or the “H” level, at the same time, the charge pump circuits PB1, PB2 are deactivated, and supply of a current to the line of the internal power supply voltage VPP from the internal voltage generation circuit is suspended. Thus, the potential level of the internal power supply voltage VPP is maintained at the target voltage VPPT.

As described above, according to this first embodiment, the four charge pump circuits PA1, PA2, PB1, and PB2 are provided, and the two charge pump circuits PA1, PA2 are driven with the long period at time of standby mode and the four charge pump circuits PA1, PA2, PB1, and PB2 are driven with the short period at time of active mode. Therefore, reduction of a layout area can be attained compared with, for example, a case where the charge pump circuit for standby mode and the charge pump circuit for active mode are provided separately.

### Second Embodiment

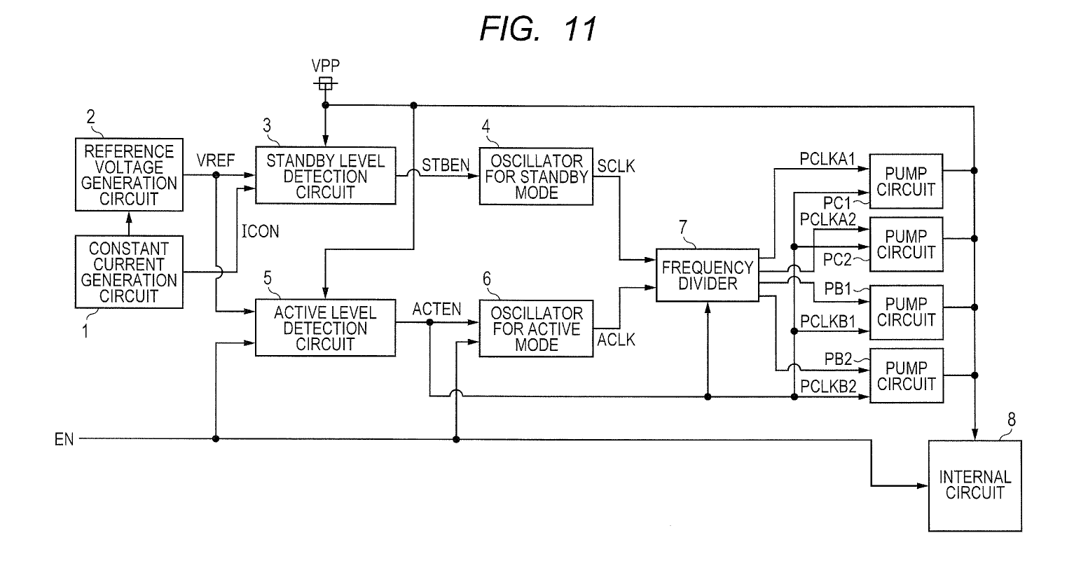

FIG. 11 is a block diagram showing a principal part of a semiconductor device according to a second embodiment of the present application, and is a figure that is contrasted with FIG. 1. With reference to FIG. 1, a point in which this semiconductor device differs from the semiconductor device of FIG. 1 is that the charge pump circuits PA1, PA2 are replaced with the charge pump circuits PC1, PC2.

When the active oscillator activation signal ACTEN is made to be “H” level of the activation level, the charge pump circuits PC1, PC2 supply positive charges to the line of the internal power supply voltage VPP with a first current supply capability in response to the charge pump clock signals PCLKA1, PCLKA2, respectively.

Moreover, when the active oscillator activation signal ACTEN is made to be “L” level of the deactivation level, the charge pump circuits PC1, PC2 supply positive charges to the line of the internal power supply voltage VPP with a second current supply capability smaller than the first current supply capability in response to the charge pump clock signals PCLKA1, PCLKA2, respectively.

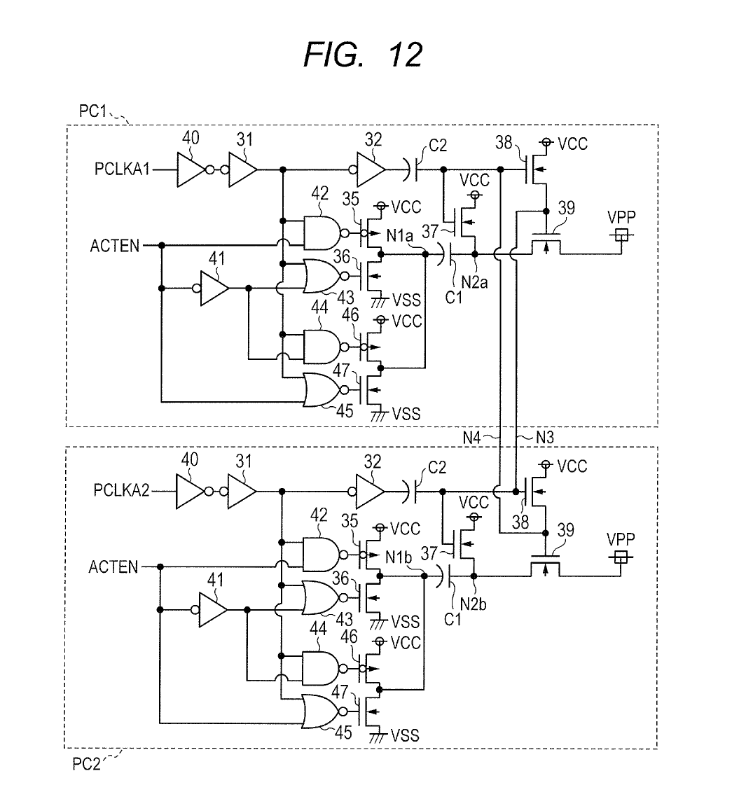

FIG. 12 is a circuit diagram showing configurations of charge pump circuits PC1, PC2, and is a figure that is contrasted with FIG. 5. With reference to FIG. 12, a main point at which the charge pump circuit PC1 differs from the charge pump circuit PA1 is that the NAND gate 30 and the inverters 33, 34 are removed, and inverters 40, 41, NAND gates 42, 44, NOR gates 43, 45, a P-channel MOS transistor 46, and an N-channel metal oxide semiconductor transistor 47 are provided. A size (a current driving capability) of the transistors 46, 47 is smaller than a size (a current driving capability) of the transistors 35, 36.

The charge pump clock signal PCLKA1 is given to the one input nodes of the NAND gates 42, 44 and the NOR gates 43, 45 through the inverters 40, 31, respectively. The active oscillator activation signal ACTEN is given directly to respective other input nodes of the NAND gate 42 and the NOR gate 45 and, at the same time, is given to other input nodes of the NOR gate 43 and the NAND gate 44 through the inverter 41, respectively.

When the internal power supply voltage VPP is lower than the target voltage VPPT at the time of active mode, the active oscillator activation signal ACTEN is made to be “H” level of the activation level. In this case, each of the NAND gate 42 and the NOR gate 43 operates as an inverter to the output clock signal of the inverter 31. Moreover, output signals of the NAND gate 44 and the NOR gate 45 are fixed to the “H” level and the “L” level, respectively, and both the transistors 46, 47 are fixed to a non-conductive state. In this case, the charge pump circuit PC1 has the same configuration as that of the charge pump circuit PA1.

The NAND gate 42, the NOR gate 43, and the transistors 35, 36 are activated when the signal ACTEN is on the “H” level, and are included in a first driver for giving the external power supply voltage VCC and the ground voltage VSS alternately to one electrode of the capacitor C1 in response to the clock signal PCLKA1.

Moreover, either when the internal power supply voltage VPP becomes more than or equal to the target voltage VPPT at the time of active mode or at the time of standby mode, the active oscillator activation signal ACTEN is made to be “L” level of the deactivation level. In this case, each of the NAND gate 44 and the NOR gate 45 operates as an inverter to the output clock signal of the inverter 31. Moreover, the output signals of the NAND gate 42 and the NOR gate 43 are fixed to the “H” level and “L” level, respectively, and both the transistors 35, 36 are fixed to a non-conductive state. In this case, the charge pump circuit PC1 has a configuration in which the transistors 35, 36 of the charge pump circuit PA1 are replaced with the transistors 46, 47 of small current driving capacities.

The NAND gate 44, the NOR gate 45, and the transistors 46, 47 are activated when the signal ACTEN is on the “L” level, and are included in a second driver of the capacitor C1 that gives the external power supply voltage VCC and the ground voltage VSS alternately to a one electrode of the capacitor C1 in response to the clock signal PCLKA1. A current driving capability of the second driver is smaller than a current driving capability of the first driver.

The charge pump circuit PC2 has the same configuration as that of the charge pump circuit PC1 but differs therefrom only in a point that the charge pump clock signal PCLKA2 is inputted into it instead of the charge pump clock signal PCLKA1.

Next, an operation of this semiconductor device will be explained. At the time of standby mode, the activation signal EN is made to be “L” level of the deactivation level, the active level detection circuit 5, the oscillator 6 for active mode, and the internal circuit 8 in FIG. 11 are deactivated, and the signals ACTEN, ACLK are fixed to the “L” level. Thereby, the charge pump circuits PB1, PB2 are deactivated and the transistors 35, 36 of each of the charge pump circuits PC1, PC2 are fixed to a non-conductive state.

When the internal power supply voltage VPP is lower than the target voltage VPPT in the standby mode, the standby oscillator activation signal STBEN is made to be “H” level by the standby level detection circuit 3, and the standby clock signal SCLK of the long period is generated by the oscillator 4 for standby mode. The standby clock signal SCLK is delayed by the NAND gates 25, 26 of the frequency divider 7 of FIG. 2 to become the charge pump clock signal PCLKA1, which is further inverted by the inverter 27 to become the charge pump clock signal PCLKA2.

In response to the charge pump clock signal PCLKA1, the transistors 46, 47 of the charge pump circuit PC1 turn on alternately, and a positive current is supplied to the line of the internal power supply voltage VPP. Moreover, in response to the charge pump clock signal PCLKA2, the transistors 46, 47 of the charge pump circuit PC2 turn on alternately, and a positive current is supplied to the line of the internal power supply voltage VPP.

When the internal power supply voltage VPP is more than or equal to the target voltage VPPT in the standby mode, the standby oscillator activation signal STBEN is made to be “L” level by the standby level detection circuit 3, and the standby clock signal SCLK is fixed to the “L” level. Therefore, the charge pump clock signals PCLKA1, PCLKA2 are fixed to the “L” level and the “H” level, respectively, and operations of the charge pump circuits PC1, PC2 are suspended.

At the time of active mode, the activation signal EN is made to be “H” level of the activation level, the active level detection circuit 5 and the internal circuit 8 of FIG. 11 are activated, and activation of the oscillator 6 for active mode and the charge pump circuits PB1, PB2, PC1, and PC2 becomes possible.

When the internal power supply voltage VPP is lower than the target voltage VPPT in the active mode, the active oscillator activation signal ACTEN is made to be “H” level by the active level detection circuit 5, and the active clock signal ACLK of the short period is generated by the oscillator 6 for active mode. The active clock signal ACLK is frequency-divided, delayed, and inverted by the frequency divider 7 of FIG. 2 to become the charge pump clock signals PCLKA1, PCLKA2, PCLKB1, and PCLKB2.

In response to the charge pump clock signal PCLKA1, the transistors 35, 36 of the charge pump circuit PC1 turn on alternately, and a positive current is supplied to the line of the internal power supply voltage VPP. Moreover, in response to the charge pump clock signal PCLKA2, the transistors 35, 36 of the charge pump circuit PC2 turn on alternately, and a positive current is supplied to the line of the internal power supply voltage VPP.

Moreover, in response to the charge pump clock signal PCLKB1, the transistors 35, 36 of the charge pump circuit PB1 turn on alternately, and a positive current is supplied to the line of the internal power supply voltage VPP. Moreover, in response to the charge pump clock signal PCLKB2, the transistors 35, 36 of the charge pump circuit PB2 turn on alternately, and a positive current is supplied to the line of the internal power supply voltage VPP.

When the internal power supply voltage VPP is more than or equal to the target voltage VPPT in the active mode, the active oscillator activation signal ACTEN is made to be “L” level by the active level detection circuit 5, and the active clock signal ACLK is fixed to the “L” level. Moreover, the standby oscillator activation signal STBEN is made to be “L” level by the standby level detection circuit 3, and the standby clock signal SCLK is fixed to the “L” level. Therefore, each of the charge pump clock signals PCLKA1, PCLKA2, PCLKB1, and PCLKB2 is fixed to the “L” level or the “H” level, and operations of the charge pump circuits PC1, PC2, PB1, and PB2 are suspended.

In this second embodiment, it is possible to attain the same effect as that of the first embodiment, and in addition to this, it is possible to attain the reduction of the consumption current since current supply capabilities of the charge pump circuits PC1, PC2 are reduced at the time of standby mode.

As described above, although the invention made by the present inventors was concretely explained based on the embodiments, it goes without saying that the present invention is not limited to the embodiments and can be modified variously within a range that does not deviate from its gist.

What is claimed is:

1. An internal voltage generation circuit for generating an internal power supply voltage based on an external power supply voltage in a semiconductor device that has a standby mode and an active mode, comprising:
a clock generation circuit that generates a first charge pump clock signal at the time of standby mode and generates second and third charge pump clock signals of a short period that is shorter than that of the first charge pump clock signal at the time of active mode;
a first charge pump circuit that is driven by an external power supply voltage and supplies electric charges to a line of the internal power supply voltage in response to the first and second charge pump clock signals; and
a second charge pump circuit that is driven by the external power supply voltage and supplies electric charges to the line of the internal power supply voltage in response to the third charge pump clock signal.

2. The internal voltage generation circuit according to claim 1, further comprising:
a level detection circuit that detects whether a level of the internal power supply voltage has reached a target voltage and outputs a signal that indicates a detection result,
wherein the clock generation circuit:
operates based on an output signal of the level detection circuit;
generates the first charge pump clock signal when the level of the internal power supply voltage has not reached the target voltage in the standby mode;
generates the second and third charge pump clock signals when the level of the internal power supply voltage has not reached the target voltage in the active mode; and
suspends generation of the first to third charge pump clock signals when the level of the internal power supply voltage has reached the target voltage.

3. The internal voltage generation circuit according to claim 2,
wherein the level detection circuit includes:
a standby level detection circuit that outputs a first signal when the level of the internal power supply voltage has not reached the target voltage, and suspends the output of the first signal when the level of the internal power supply voltage has reached the target voltage; and
an active level detection circuit that is activated at the time of active mode, outputs a second signal when the level of the internal power supply voltage has not reached the target voltage, and suspends the output of the second signal when the level of the internal power supply voltage has reached the target voltage, and
wherein the clock generation circuit includes:
an oscillator for standby mode that is activated when the first signal is outputted from the standby level detection circuit and generates a first clock signal;
an oscillator for active mode that is activated when the second signal is outputted from the active level detection circuit and generates a second clock signal of a shorter period than that of the first clock signal; and
a logical circuit that generates the first charge pump clock signal based on the first clock signal at the time of standby mode, and generates the second and third charge pump clock signals based on the second clock signal at the time of active mode.

4. The internal voltage generation circuit according to claim 3,
wherein the first charge pump circuit includes:
a first capacitor whose one electrode is coupled to a line of the internal power supply voltage;
a first driver that is activated when the second signal is outputted from the active level detection circuit, and gives a ground voltage and the external power supply voltage alternately to another electrode of the first capacitor in response to the first charge pump clock signal; and
a second driver that is activated when the second signal is not outputted from the active level detection circuit, and gives the ground voltage and the external power supply voltage alternately to the other electrode of the first capacitor in response to the first charge pump clock signal, and
wherein a current driving capability of the second driver is smaller than a current driving capability of the first driver.
